(19) United States
(12) Patent Application Publication
(10) Pub. No.: US 2008/0152890 A1
(43) Pub. Date: Jun. 26, 2008

(54) Structural element and method for producing the same

(75) Inventors: Martin Friess, Frickenhausen (DE); Martin Nedele, Reutlingen (DE)

Correspondence Address: Lipsitz & McAllister, LLC, 755 MAIN STREET, MONROE, CT, 06468, US

(73) Assignee: Deutsches Zentrum fuer Luft-und Raumfahrt e.V., Koeln (DE)

(21) Appl. No.: 11/998,449

(22) Filed: Nov. 29, 2007

Related U.S. Application Data
(63) Continuation of application No. PCT/EP2006/005180, filed on May 31, 2006.

(30) Foreign Application Priority Data
Jun. 3, 2005 (DE) 10 2005 026 635

(51) Int. Cl. B32B 18/00; B05D 1/18; B05D 5/12; C23C 4/08

(52) U.S. Cl. 428/292.1; 427/431; 427/123; 427/455

(57) ABSTRACT

To produce a structural element that withstands corrosive and/or abrasive flows of hot gas during a predetermined service life and, on the other hand, can be advantageously produced, it is proposed that the structural element comprises a fiber-ceramic main body, in that the main body is formed by a C/C shaped body having a fiber-ceramic structure converted with Si to C/C—SiC in a volume region bordering on an upper side of the main body, and in that a coating comprising a metal is applied to at least a partial region of the upper side of the main body.

This application is a continuation of International application No. PCT/EP2006/005180 filed on May 31, 2006.

This patent application claims the benefit of International application No. PCT/EP2006/005180 of May 31, 2006 and German application No. 10 2005 026 635.5 of Jun. 3, 2005, the teachings and disclosure of which are hereby incorporated in their entirety by reference thereto.

### BACKGROUND OF THE INVENTION

The invention relates to a structural element that withstands corrosive and/or abrasive flows of hot gas.

As is well known, components made of refractory metals and alloys, such as tungsten, molybdenum, rhenium, or monolithic ceramics, such as SiC, are used as such structural elements.

Problems relating to the temperature stability arise with the refractory metals, which makes it necessary to actively cool the structural elements during use. Moreover, an appreciable removal of material occurs owing to the corrosive and/or abrasive flows of hot gas acting thereon.

Owing to their high weight as a result of high density, such refractory metals are also disadvantageous for mobile applications.

The monolithic ceramics also used for such structural elements have the disadvantage that their resistance to dynamic loads and thermal shocks is low, and, in addition, the possibilities of shaping the structural elements are considerably limited.

It is therefore an object of the invention to create a structural element of the kind described at the outset which, on the one hand, is able to withstand corrosive and/or abrasive flows of hot gas during a predetermined service life and, on the other hand, can be advantageously produced.

### SUMMARY OF THE INVENTION

This object is achieved according to the invention with a structural element of the kind described at the outset by the structural element comprising a fiber-ceramic main body, by the main body being formed by a C/C shaped body having a fiber-ceramic structure converted with Si to C/C—SiC in a volume region bordering on an upper side of the main body, and by a coating comprising a metal being applied to at least a partial region of the upper side of the main body.

The advantage of the solution according to the invention is to be seen in that, by using a main body comprising a C/C shaped body with a volume region comprising a C/C—SiC structure, a very cost-effective and easily shaped main body is made available and in that this main body can be provided in a similarly cost-effective manner with the coating comprising a metal, which on account of its elasticity has advantageous dynamic properties and thermal shock-resistant properties.

The coating has advantageous properties in particular whenever it comprises a refractory metal.

Furthermore, it is advantageous if the coating comprises at least one metal from the following metals: silicon, titanium, zirconium, hafnium, vanadium, niobium, tantalum, chromium, molybdenum, tungsten, technetium, rhenium, ruthenium, osmium, rhodium, iridium and platinum.

The coating may in this case be formed in any number of different ways. A suitable solution provides that the coating is a metal coating, that is to say that it is produced from one of the aforementioned metals.

Another advantageous solution provides that the coating is an alloy coating, which may contain a number of the aforementioned metals but also further components.

Particularly advantageous properties are achieved if the coating is an alloy coating and comprises boron as the alloying component.

With regard to the use of the coating itself, no further details have been specified in connection with the solution described so far. So, one possibility provides using the coating according to the invention as a top layer of the structural element.

On account of the advantageous “elastic properties” of the coating according to the invention that are described above, the coating acts on the one hand in a protective manner with respect to the corrosive and/or abrasive flows of hot gas and on the other hand in a particle-repelling manner, or optionally a particle-accepting manner, so that as a result the fiber-ceramic structure covered by the coating can be adequately protected during an intended service life.

In particular, it is ensured on account of the advantageous properties of the materials described above that the coating covers the fiber-ceramic structure reliably and without any cracks, and consequently reliably protects it, in the intended region.

Another advantageous solution provides that the coating is an intermediate layer for a top layer carried by it.

In this case, on account of its “elastic” and “soft” properties, the coating serves the purpose of forming a base layer or a carrier layer for the top layer, so that the top layer adheres better on the fiber-ceramic structure of the main body and remains durably and stably bonded to it, even under alternating thermal loads. In this case, the base layer or carrier layer can in particular also chemically react partially or completely with the top layer.

The top layer may in this case be formed in any number of different ways.

A suitable solution provides that the top layer is a ceramic hard material coating.

Such a ceramic hard material coating is suitably applied to the coating according to the invention described above by plasma spraying and/or PVD processes (physical vapor deposition processes) and/or CVD processes (chemical vapor deposition processes) and/or a slurry technique.

In order to avoid detachment of the hard material coating from the main body, it is advantageously provided that the thickness of the ceramic hard material coating is less than approximately 1 mm.

It is still better if the thickness of the ceramic hard material coating is less than approximately 0.5 mm.

In order, however, also to achieve an advantageous protective effect, it is preferably provided that the thickness of the ceramic hard material coating is at least approximately 0.01 mm, still better approximately 0.05 mm.

For its part, the ceramic hard material coating has not so far been specified in any more detail.

It has proven to be particularly advantageous if the ceramic hard material coating has a hardness that is greater than that of corundum.

Preferred materials for hard material coatings are, for example, oxides and/or nitrides and/or borides.

As an alternative or in addition to this, it is provided that the ceramic hard material coating comprises carbides.

Preferred carbides are, for example, boron carbides and/or silicon carbides.

Other carbides are preferably carbides of the transition metals, in particular the transition metals of the fourth and/or fifth and/or sixth subgroup.

A further preferred solution provides that the hard material coating comprises diamond.

In addition, the invention relates to a method for producing a structural element that withstands corrosive and/or abrasive flows of hot gas.

According to the invention, such a method for producing a structural element that withstands corrosive and/or abrasive flows of hot gas comprises producing a C/C shaped body from carbon fibers and a carbon-containing matrix by pyrolysis, forming a main body of the structural element by providing the C/C shaped body with a volume region bordering on an upper side of the main body that has a fiber-ceramic structure converted into C/C—SiC by introducing Si in this volume region and providing at least a partial region of the upper side with a coating comprising a metal.

The advantage of the method according to the invention is likewise to be seen in that the main body is provided in a cost-effective manner with the coating comprising a metal, which on account of its elasticity has advantageous dynamic properties and thermal shock-resistant properties.

Here it is advantageous in particular if the coating is applied as a coating of refractory metal.

Furthermore, it is advantageous if the coating is produced from at least one metal of the following metals: silicon, titanium, zirconium, hafnium, vanadium, niobium, tantalum, chromium, molybdenum, tungsten, technetium, rhenium, ruthenium, osmium, rhodium, iridium and platinum.

In particular, it is suitably provided that the coating is produced as a metal coating.

Another advantageous solution provides that the alloy coating comprises boron.

The application of the coating comprising metal may be performed in any number of different ways.

An advantageous solution provides that the coating comprising metal is applied by immersion in a molten metal.

Another advantageous solution provides that the coating comprising metal is galvanically applied.

A further advantageous solution provides that the coating comprising metal is applied by plasma spraying.

Furthermore, it is advantageous within the scope of the solution according to the invention if the coating comprising metal is applied by a PVD process (physical vapor deposition process).

A further advantageous solution provides that the coating comprising metal is applied by a CVD process (chemical vapor deposition process).

Finally, a further advantageous solution provides that the coating comprising metal is applied by melting powder.

Within the scope of the solution according to the invention, the coating comprising metal may be applied as a top layer.

As an alternative to this, another advantageous solution provides that the coating is applied as an intermediate layer for a top layer carried by it.

It is preferably provided in this respect that a ceramic hard material coating is applied as the top layer.

Such a ceramic hard material coating may be applied in various ways.

One possibility provides applying the top layer by plasma spraying.

A further possibility provides applying the top layer by a CVD process (chemical vapor deposition process).

Finally, one solution provides applying the top layer by a PVD process (physical vapor deposition process).

A further solution provides applying the ceramic material by a slurry technique.

Preferably, the hard material coating is in this case also applied with a thickness of less than approximately 1 mm.

In this case, the thickness of the hard material coating is at least approximately 0.01 mm.

The application of the ceramic hard material coating by plasma spraying is performed in particular by vacuum plasma spraying, in order to obtain good bonding between the ceramic hard material coating and the upper side of the main body for the component.

Furthermore, the ceramic hard material coating is preferably produced by applying materials that produce a hard material coating of a hardness greater than that of corundum.

It is particularly advantageous if the ceramic hard material coating is produced by applying materials that produce a hard material coating on the basis of oxides and/or nitrides and/or borides.

Another advantageous method for producing the ceramic hard material coating is to apply materials that produce a hard material coating on the basis of carbides.

Preferred such carbides are boron carbides and/or silicon carbides.

Other carbides are carbides of the transition metals, in particular the transition metals of the fourth and/or fifth and/or sixth subgroup.

Further features and advantages of the invention are the subject of the following description and the graphic representation of a number of embodiments of the invention.

### BRIEF DESCRIPTION OF THE DRAWINGS

FIG. 1 shows an exemplary embodiment of a flying object with structural elements according to the invention;

FIG. 2 shows a cross-section through a detail from a wall of a first exemplary embodiment of a structural element according to the invention and

FIG. 3 shows a cross-section similar to FIG. 2 through a detail from a wall of a second exemplary embodiment of the structural element according to the invention.

### DETAILED DESCRIPTION OF THE INVENTION

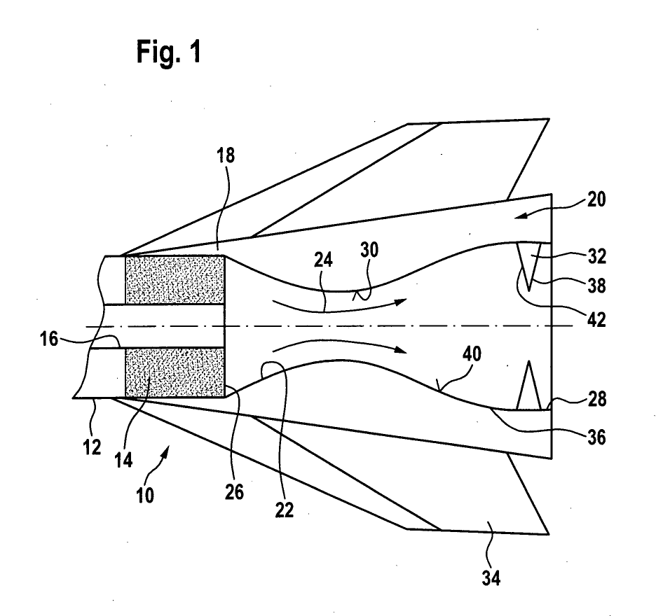

An exemplary embodiment of an engine, represented in FIG. 1 and designated as a whole by 10, for a flying object comprises a solid propellant 14 that is disposed in a housing 12 and is also provided, for example, with a central passage 16.

An end 18 of the housing 12 which is usually at the rear is followed by a tail cone 20, disposed in which is a nozzle 22, through which there passes a flow of hot gas 24, which forms during combustion of the propellant 14 and exits from the housing 12 in the region of the end 18.

The flow of hot gas 24 thereby enters an end 26 of the nozzle 22 on the side at which the propellant is located and passes from an exit end 28 of the nozzle into the environment, the nozzle 22 having a constriction 30 between the end 26 on the side at which the propellant is located and the exit end 28.

Provided in the nozzle 22 near the exit end 28 thereof are jet-deflecting vanes 32, which serve the purpose of influencing the flow of hot gas 24 immediately before it exits through the exit end 28 of the nozzle 22, in order to thereby steer the flying object.

The tail cone 20 also additionally comprises, for example, outer, flight-stabilizing air guides 34, also referred to as fins.

Since the flow of hot gas 24 resulting from the solid propellant 14 contains not only hot gases but also, owing to combustion of the solid material, corrosive and/or abrasive particles, both an inner wall 36 that guides the flow of hot gas 24 and an outer wall 38 of the jet-deflecting vanes 32 are provided with a surface 40 and 42, respectively, which withstands the corrosively and/or abrasively acting particles carried along by the flow of hot gas 24 during an intended service life.

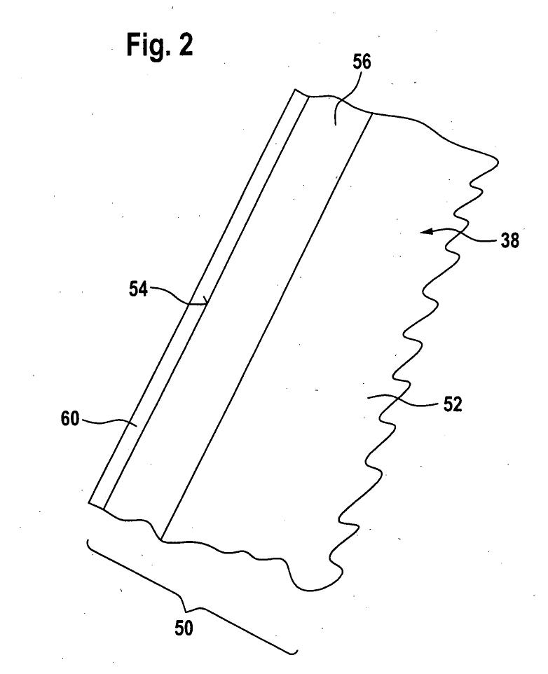

A construction according to the invention of such an inner wall 36 or such an outer wall 38 of a first exemplary embodiment of a structural element according to the invention is shown by way of example in FIG. 2 in the example of a detail from the outer wall 38 of a jet-deflecting vane 32.

The outer wall 38 is in this case formed by a main body 50, which is constructed as a fiber-ceramic C/C shaped body.

Such a C/C shaped body is produced by mixing carbon fibers with a carbon-containing matrix material and pyrolizing the matrix material to carbon.

Furthermore, by the infiltration of silicon in a volume region 56 adjoining an upper side 54 of the shaped body 52, said shaped body 52 is converted into a fiber-ceramic structure comprising C/C—SiC, the formation of SiC in the volume region 56 imparting a greater hardness and stiffness to the outer wall 38.

The volume region 56 with the fiber-ceramic structure comprising C/C—SiC thus comprises a multi-component composite material and can constitute a partial region of the outer wall 38. The volume region 56 may, however, also extend through the entire outer wall 38 and thereby impart altogether a higher mechanical stability to the outer wall 38.

The amount of SiC in the volume region 56 is preferably up to 50%, the remainder being carbon.

In the case of a first embodiment, the upper side 54 of the main body 50 is provided with a coating 60 comprising a metal, which is applied for example by deposition on the main body 50 from the melt phase.

As an alternative to this, the coating 60 may also be provided by deposition from the vapor phase, by applying a powder phase, by applying a powder phase by plasma spraying or laser welding.

One or more of the following metals may come into consideration as materials for the coating 60:

silicon, titanium, zirconium, hafnium, vanadium, niobium, tantalum, chromium, molybdenum, tungsten, technetium, rhenium, ruthenium, osmium, rhodium, iridium and platinum.

The aforementioned metals may form a pure metal coating or else an alloy coating as the coating 60.

In the case of an alloy coating, it is also conceivable to provide boron as a constituent thereof.

In the case of the first exemplary embodiment, the coating 60 represents a top layer that constitutes protection for the main body 50 from corrosive and/or abrasive flows of hot gas.

The protective function for the main body 50 is achieved by the “soft” and “elastic” properties of the materials referred to that are provided in the coating 60 with respect to the corrosive and/or abrasive constituents of the hot gas flows, the thickness of the coating 60 in the case of the first exemplary embodiment lying in the range from approximately 0.01 mm to approximately 2 mm, preferably in the range from approximately 0.1 mm to approximately 2 mm.

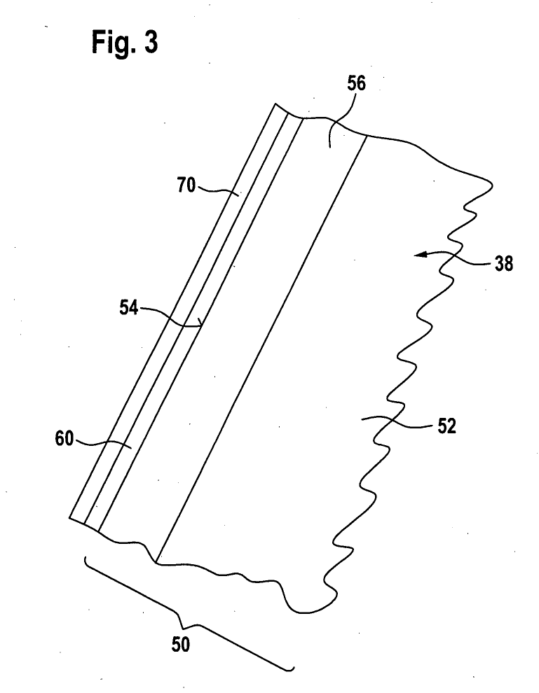

In the case of a second exemplary embodiment of a structural element according to the invention, the coating 60 described is an intermediate layer between the main body 50 and a ceramic hard material coating 70 as a top layer, as represented in FIG. 3.

In the case of the second exemplary embodiment, the coating 60 serves, on account of its “soft” and “elastic” properties and/or chemical properties, the purpose of creating a balance between the behavior of the main body 50 and the ceramic hard material coating 70, in particular in order to prevent spalling of the ceramic top layer 70.

In the case of the second exemplary embodiment, the thickness of the coating 60 lies in the range from approximately 1 nm to approximately 0.5 mm.

The ceramic hard material coating 70 forms a protective coating for the outer wall 38, capable of withstanding the corrosive and/or abrasive flow of hot gas 24.

The ceramic hard material coating 70 preferably has a hardness greater than that of corundum (Al₂O₃). According to the invention, suitable ceramic hard material coatings that are harder than corundum are, in particular, oxides, nitrides and borides.

Suitable materials for the formation of the ceramic hard material coating 70 are also boron carbides, for example B₄C, and/or silicon carbides and/or transition metal carbides, preferably transition metal carbides of the elements of the fourth and/or fifth and/or sixth subgroup, such as for example titanium, vanadium, chromium, zirconium, niobium, molybdenum, hafnium, tantalum and/or tungsten.

The layer thickness of the ceramic hard material coating 70 is preferably less than approximately 1 mm. Advantageous values for the thickness of the ceramic hard material coating are less than 0.5 mm, for example between 0.1 and 0.3 mm. In the case of hard material coatings 70 of such a thickness, spalling of the ceramic hard material coating under alternating thermal loads can be avoided.

A jet-deflecting vane 32 according to the invention can preferably be produced by a blank largely corresponding to the shape of the jet-deflecting vane 32 being formed as an inherently stiff and stable blank from a molding material comprising carbon fibers and a carbon-containing matrix material and by curing the matrix material, as described for example by reference to the example of brake disks in the publication “Bremsscheiben aus keramischen Verbundwerkstoffen für Schienenfahrzeuge” [brake disks of ceramic composite materials for rail vehicles], H. Pfeiffer et al., DGM Werkstoffwoche '96, 28-31-5, 1996, Stuttgart.

Such a blank is subsequently converted by pyrolysis of the matrix material into the C/C shaped body 52, which is either given the final shape of the jet-deflecting vane 32 by working the material, for example machining it, before or after the pyrolysis or already has the final shape of the jet-deflecting vane 32 after the pyrolysis as a result of suitable shaping of the blank before the curing.

Infiltration with silicon is subsequently performed to form the volume region 56 comprising C/C—SiC, for example by the LSI process described in the above publication, the volume region 56 either constituting just a partial region of the outer wall 38 of the jet-deflecting body or extending entirely through it.

The coating 60 with the aforementioned materials or with alloys of the same is then applied to the upper side 54 of the main body 50.

If, as in the case of the first exemplary embodiment, the coating 60 is the top layer, the jet-deflecting vane 32 is obtained in the final configuration immediately after application of the coating 60, otherwise the ceramic hard material coating 70 also has to be additionally applied as the top layer.

1. Structural element that withstands corrosive and/or abrasive flows of hot gas, the structural element comprising a fiber-ceramic main body, the main body being formed by a C/C shaped body having a fiber-ceramic structure converted with Si to C/C—SiC in a volume region bordering on an upper side of the main body, and a coating comprising a metal is applied to at least a partial region of the upper side of the main body.

2. Structural element according to claim 1, wherein the coating comprises a refractory metal.

3. Structural element according to claim 1, wherein the coating comprises at least one metal from the following metals: silicon, titanium, zirconium, hafnium, vanadium, niobium, tantalum, chromium, molybdenum, tungsten, technetium, rhenium, ruthenium, osmium, rhodium, iridium and platinum.

4. Structural element according to claim 1, wherein the coating is a metal coating.

5. Structural element according to claim 1, wherein the coating is an alloy coating.

6. Structural element according to claim 5, wherein the alloy coating comprises boron.

7. Structural element according to claim 1, wherein the coating forms a top layer of the structural element.

8. Structural element according to claim 1, wherein the coating is an intermediate layer for a top layer carried by it.

9. Structural element according to claim 8, wherein the top layer is a ceramic hard material coating.

10. Structural element according to claim 9, wherein the hard material coating is applied by plasma spraying.

11. Structural element according to claim 9, wherein the hard material coating is applied by a PVD process.

12. Structural element according to claim 9, wherein the hard material coating is applied by a CVD process.

13. Structural element according to claim 9, wherein the hard material coating is applied by a slurry process.

14. Structural element according to claim 10, wherein the thickness of the ceramic hard material coating is less than approximately 1 mm.

15. Structural element according to claim 9, wherein the thickness of the ceramic hard material coating (60) is less than approximately 0.5 mm.

16. Structural element according to claim 9, wherein the thickness of the ceramic hard material coating is at least 0.01 mm.

17. Structural element according to claim 9, wherein the ceramic hard material coating has a hardness that is greater than that of corundum.

18. Structural element according to claim 9, wherein the ceramic hard material coating comprises oxides and/or nitrides and/or borides.

19. Structural element according to claim 9, wherein the ceramic hard material coating comprises carbides.

20. Structural element according to claim 19, wherein the ceramic hard material coating comprises boron carbides.

21. Structural element according to claim 19, wherein the ceramic hard material coating comprises silicon carbides.

22. Structural element according to claim 19, wherein the ceramic hard material coating comprises carbides of the transition metals.

23. Structural element according to claim 19, wherein the ceramic hard material coating comprises carbides of metals of the fourth and/or fifth and/or sixth subgroup.

24. Structural element according to claim 9, wherein the ceramic hard material coating comprises diamond.

25. Method for producing a structural element that withstands corrosive and/or abrasive flows of hot gas, comprising the following step producing a C/C shaped body from carbon fibers and a carbon-containing matrix by pyrolysis, producing a main body of the structural element is produced by providing the C/C shaped body with a volume region bordering on an upper side of the main body that has a fiber-ceramic structure converted into C/C—SiC by introducing Si into this volume region and producing at least a partial region of the upper side with a coating comprising a metal.

26. Method according to claim 25, wherein the coating is applied as a coating of refractory metal.

27. Method according to claim 25, wherein the coating is produced from at least one metal from the following metals: silicon, titanium, zirconium, hafnium, vanadium, niobium, tantalum, chromium, molybdenum, tungsten, technetium, rhenium, ruthenium, osmium, rhodium, iridium and platinum.

28. Method according to claim 25, wherein the coating is produced as a metal coating.

29. Method according to claim 25, wherein the coating is produced as an alloy coating.

30. Method according to claim 29, wherein the alloy coating comprises boron.

31. Method according to claim 25, wherein the coating comprising metal is applied by immersion in a molten metal.

32. Method according to claim 25, wherein the coating comprising metal is galvanically applied.

33. Method according to claim 25, wherein the coating comprising metal is applied by plasma spraying.

34. Method according to claim 25, wherein the coating comprising metal is applied by a PVD process.

35. Method according to claim 25, wherein the coating comprising metal is applied by a CVD process.

36. Method according to claim 25, wherein the coating comprising metal is applied by melting powder.

37. Method according to claim 25, wherein the coating is applied as a top layer of the structural element.

38. Method according to claim 25, wherein the coating is applied as an intermediate layer for a top layer carried by it.

39. Method according to claim 38, wherein a ceramic hard material coating is applied as the top layer.

40. Method according to claim 38, wherein the top layer is applied by plasma spraying.

41. Method according to claim 38, wherein the top layer is applied by a CVD process.

42. Method according to claim 38, wherein the top layer is applied by a PVD process.

43. Method according to claim 37, wherein the top layer is applied by a slurry process.

44. Method according to claim 39, wherein the hard material coating is applied with a thickness of less than 1 mm.

45. Method according to claim 39, wherein the hard material coating is applied with a thickness of less than 0.5 mm.

46. Method according to claim 39, wherein the thickness of the ceramic hard material coating is at least approximately 0.01 mm.

47. Method according to claim 39, wherein the ceramic hard material coating is produced by applying materials that produce a hard material coating of a hardness greater than that of corundum.

48. Method according to claim 39, wherein the ceramic hard material coating is produced by applying materials that produce a hard material coating on the basis of oxides and/or nitrides and/or borides.

49. Method according to claim 39, wherein the ceramic hard material coating is produced by applying materials that produce a hard material coating on the basis of carbides.

50. Method according to claim 49, wherein the materials used for applying form boron carbides in the hard material coating.

51. Method according to claim 49, wherein the materials used for applying form silicon carbides in the hard material coating.

52. Method according to claim 49, wherein the carbides forming during the application are carbides of the transition metals, in particular the transition metals of the fourth and/or fifth and/or sixth subgroup.
